(19) United States
(12) Patent Application Publication
(10) Pub. No.: US 2016/0306569 A1
(43) Pub. Date: Oct. 20, 2016

(54) MEMORY SYSTEM

(71) Applicant: KABUSHIKI KAISHA TOSHIBA, Tokyo (JP)

(72) Inventors: Kyosei Yanagida, Yokohama Kanagawa (JP); Katsuhiko Ueki, Tokyo (JP)

(21) Appl. No.: 14/686,973

(22) Filed: Apr. 15, 2015

(51) Int. Cl. G06F 3/06; G06F 11/07

(52) U.S. Cl. CPC G06F 3/0616; G06F 3/0659; G06F 3/0679; G06F 11/073; G06F 11/076; G06F 11/0793

(57) ABSTRACT

According to one embodiment, a memory system includes a nonvolatile memory, a controller configured to control the nonvolatile memory, and a first list and a second list that register address information in the nonvolatile memory.

### CROSS-REFERENCE TO RELATED APPLICATIONS

This application claims the benefit of U.S. Provisional Application No. 62/120,628, filed Feb. 25, 2015, the entire contents of which are incorporated herein by reference.

### FIELD

Embodiments relate generally to a memory system.

### BACKGROUND

A memory system comprising a nonvolatile semiconductor memory and a function of controlling the semiconductor memory is available.

### BRIEF DESCRIPTION OF THE DRAWINGS

FIG. 1 is a perspective view showing an information processing system according to a first embodiment;

FIG. 2 is a block diagram showing in detail the configuration a memory system according to the first embodiment;

FIG. 3 is an equivalent circuit diagram showing a physical block A shown in FIG. 2;

FIG. 4 is a view showing the data structures of a refresh reservation list RL and a refresh enforcement list EL according to the first embodiment;

FIG. 5 is a flowchart showing refresh enforcement determination processing according to the first embodiment;

FIG. 6 is a flowchart showing delayed refresh processing according to the first embodiment;

FIG. 7 is a view showing lists RL and EL used in delayed refresh processing;

FIG. 8 is a timing chart showing occurrence of latency in a comparative example;

FIG. 9 is a timing chart showing occurrence of latency in the first embodiment;

FIG. 10 is a view showing the data structures of a refresh reservation list RL and a refresh enforcement list EL according to a second embodiment;

FIG. 11 is a flowchart showing refresh enforcement determination processing according to the second embodiment;

FIG. 12 is a flowchart showing refresh enforcement determination processing according to a modification 1;

FIG. 13A is a view showing threshold voltages in an initial state according to the modification 1; and

FIG. 13B is a view showing threshold voltages at the time of a shift read according to the modification 1.

### DETAILED DESCRIPTION

In general, according to one embodiment, a memory system includes a nonvolatile memory, a controller configured to control the nonvolatile memory, and a first list and a second list that register address information in the nonvolatile memory. The controller is configured to first data from the nonvolatile memory, determine whether refresh operation is executed based on the first data read out from the nonvolatile memory, register address the information of the first data into the first list when the refresh operation is determined to be executed, register the address information registered in the first list into the second list, and execute the refresh operation based on the address information registered in the second list.

Various embodiments will be described hereinafter with reference to the accompanying drawings.

In the description below, like reference numbers denote substantially the same functions or elements, and description will only be given when necessary. Further, in this specification, some elements are each expressed by a plurality of expressions. However, those expressions are merely examples, and other expressions may be imparted to the elements. Further, the elements, each of which is not expressed by a plurality of expressions, may be expressed by other expressions.

### First Embodiment

### 1. Structure

[1-1. Whole Structure]

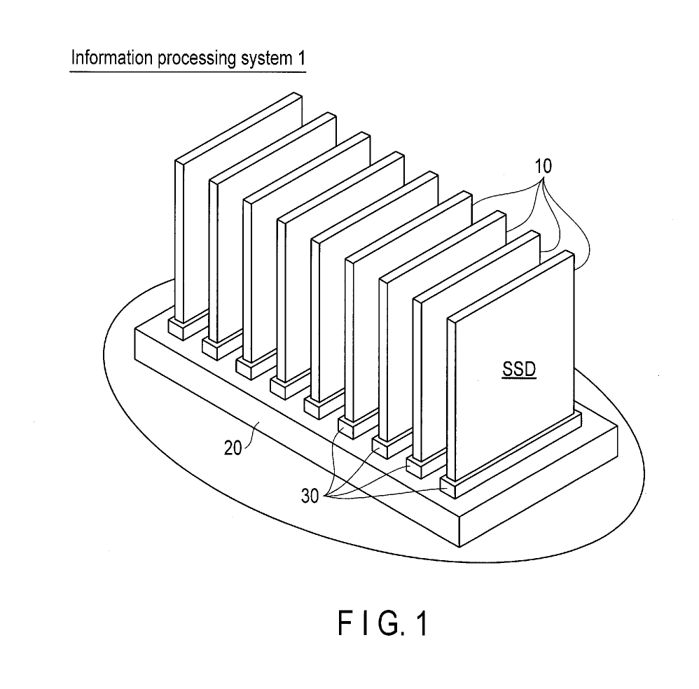

Referring first to FIG. 1, an information processing system 1 incorporating a plurality of memory systems 10 according to a first embodiment will be described. As shown, the information processing system 1 of the first embodiment comprises the memory systems 10 and a host 20 for controlling the memory systems 10. A description will be given using a solid-state drive (SSD) as an example of each memory system 10.

As shown in FIG. 1, the SSDs 10 as the memory systems of the first embodiment are, for example, relatively small modules, and have an outer size of, for example, about 20 mm×30 mm. The size of the SSDs is not limited to this, but may be changed in various ways.

Each SSD 10 can be used, attached to a host device 20, such as a server, incorporated in, for example, a data center or a cloud computing system operated in an enterprise. Thus, each SSD 10 may be an enterprise SSD (eSSD).

The host device 20 comprises a plurality of connectors (for example, slots) 30 that, for example, open upward. Each connector 30 is, for example, a Serial Attached SCSI (SAS) connector. The SAS connector enables the host device 20 and the SSD 10 to communicate with each other at high speed utilizing a 6-Gbps dual port. The connectors 30 are not limited to them, but may be of PCI Express (PCIe), NVM Express (NVMe), etc.

Further, the SSDs 10 are engaged with the respective connectors 30 of the host device 20, and are supported by them, substantially erected parallel to each other. This structure enables a plurality of memory systems 10 to be mounted together, which reduces the size of the host device 20. Further, each of the SSDs 10 is a small form factor (SFF) of 2.5 inches. The SSF shape is compatible with the shape of an enterprise HDD (eHDD), which enables each SSD to be compatible with the enterprise HDD (eHDD).

The SSD 10 is not limited to an enterprise one. For instance, the SSD 10 can be used, of course, as a memory medium for a consumer electronic device, such as a notebook computer or a tablet device.

[1-2. Memory System]

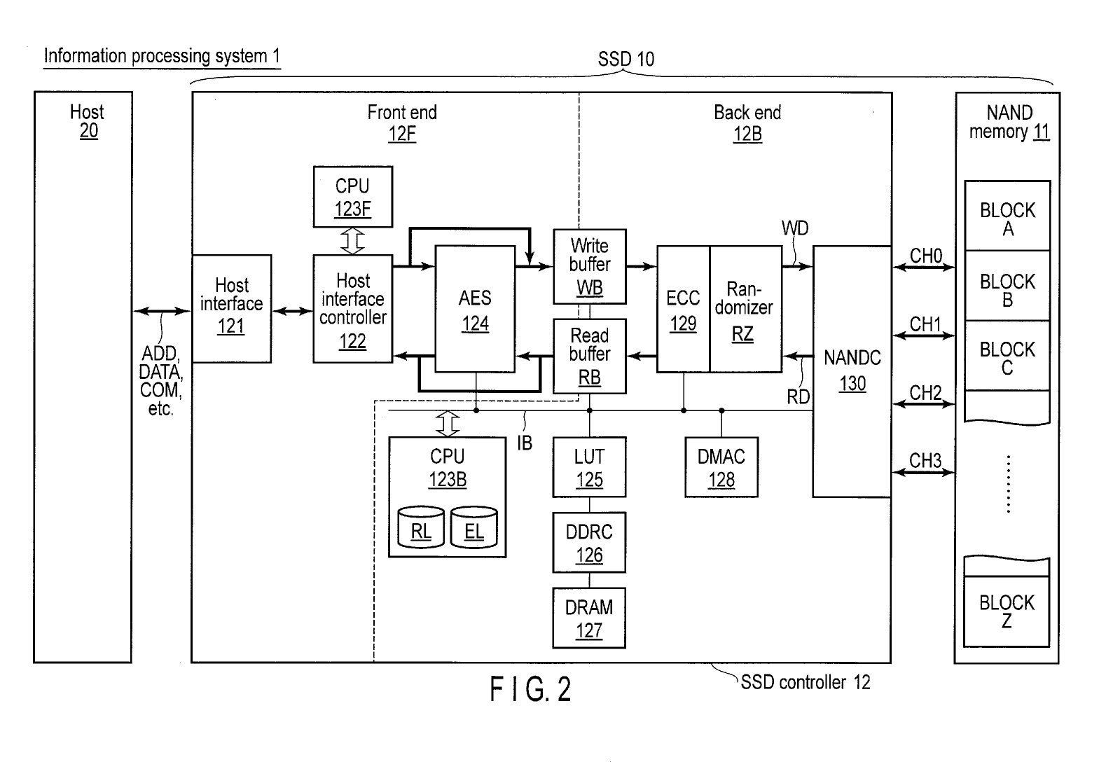

Referring then to FIG. 2, the configuration of the memory system 10 according to the first embodiment will be described in detail.

As shown, the memory system (SSD) 10 of the first embodiment comprises a NAND flash memory (hereinafter, referred to as a NAND memory) 11 and an SSD controller 12 for controlling the NAND memory 11.

The NAND memory (storage unit) is a semiconductor memory configured to store predetermined data under control of the SSD controller 12 via four channels (CH0 to CH3). The NAND memory 11 comprises a plurality of physical blocks (blocks A to Z). The physical blocks will be described later in detail.

The SSD controller (controller, memory controller) 12 controls the NAND memory 11, based on commands (such as write/read commands), addresses ADD, logical addresses LBA, data, etc., sent from the host 20. The SSD controller 12 comprises frontend 12F and backend 12B.

[Frontend 12F]

Frontend (host intermediate) 12F receives predetermined commands (such as a write command and a read command), addresses ADD, logical addresses LBA and data from the host 20, thereby analyzing the predetermined commands. Further, frontend 12F requests backend 12B to execute a data read or a data write, based on the result of analysis of the command.

Frontend 12F comprises a host interface 121, a host interface controller 122, an encryption/decryption unit 124 and CPU 123F.

The host interface 121 transmits and receives, to and from the host 20, commands (write, read, erasure commands, etc.), logical addresses LBA, data, etc.

The host interface controller (communication controller) 122 controls communication by the host interface 121 under control of CPU 123F.

An Advanced Encryption Standard (AES) unit (encryption/decryption unit) 124 encrypts, during data writing, write data (plaintext) sent from the host interface controller 122. The AES unit 124 decrypts, during data reading, encrypted read data sent from a read buffer WB included in backend 12B. Transmission of write and read data without passing through the AES unit 124 is also possible.

CPU (controller) 123F controls each of the above-mentioned elements (121 to 124) included in frontend 12F, thereby controlling the entire operation of frontend 12F.

[Backend 12B]

Backend (memory interface unit) 12B executes, for example, a predetermined garbage collection, based on a data write request from frontend 12F, the operation state of the NAND memory 11, etc., and writes, to the NAND memory 11, user data sent from the host 20. Further, based on a data read request, backend 12B reads user data from the NAND memory 11. Yet further, based on a data erasure request, backend 12B erases user data from the NAND memory 11.

Backend 12B comprises a write buffer WB, a read buffer RB, a lookup table (LUT) 125, a DDRC 126, a dynamic random access memory (DRAM) 127, a DMAC 128, an ECC 129, a randomizer RZ, a NANDC 130 and CPU 123B.

The write buffer (write data storage unit) WB temporarily stores write data WD sent from the host 20. More specifically, the write buffer WB temporarily stores write data WD until this data reaches a predetermined data size suitable for the NAND memory 11. For instance, the write buffer WB temporarily stores write data WD until this data reaches 16 KB as a page size. If each page is formed of four clusters, the write buffer WB temporarily stores write data WD until this data reaches the total data size (4 KB×4=16 KB) of the four clusters.

The read buffer (read data storage unit) RB temporarily stores read data RD read from the NAND memory 11. More specifically, the read data RD is rearranged so that it is arranged in an order convenient to the host 20 (namely, in an order of logical addresses LBA designated by the host 20).

The LUT (translation table) 125 translates a logical address LBA sent from the host 20 into a predetermined physical address PBA, using, for example, a predetermined translation table (not shown). The LUT 125 will be described later in detail.

The DDRC 126 controls double data rate (DDR) in the DRAM 127.

The DRAM 127 is used as a work area for storing, for example, the translation table of the LUT 125, and is a nonvolatile semiconductor memory for storing predetermined data.

The DMAC 128 transfers, for example, write data WD or read data RD via an internal bus IB. Although the embodiment employs one DMAC 128, a plurality of DMACs 128 may be arranged in various positions in the SSD controller 12, when necessary.

The ECC (error correction unit) 129 adds an error correction code (ECC) to write data WD sent from the write buffer WB. When transmitting read data RD to the read buffer RB, the ECC 129 corrects, if necessary, read data RD read from the NAND memory 11, using ECC added thereto.

The randomizer (scrambler) RZ distributes write data WD during writing so that the write data WD will not be biased, for example, to a particular page, or along a particular word line. By thus biasing write data WD, the number of writes can be equalized to thereby elongate the life of the memory cells MC of the NAND memory 11. This leads to enhancement of reliability of the NAND memory 11. Further, read data RD read from the NAND memory 11 passes through the randomizer RZ also during reading.

The NANDC (data write/read unit) 130 accesses the NAND memory 11 in a parallel manner through a plurality of channels (in the embodiment, the four channels CH0 to CH3), in order to process a request of a predetermined rate.

CPU (controller) 123B controls each element (125 to 130) of backend 12B to control the whole operation of backend 12B. CPU 123B comprises a refresh reservation list RL and a refresh enforcement list EL. As will be described later, it is sufficient if the above “lists RL and EL” can register at least, for example, addresses allocated to a semiconductor memory. More specifically, each of the lists RL and EL has a queue structure, and can register predetermined physical block addresses PBA allocated to the NAND memory 11. The refresh operation (hereinafter, this may be referred to simply as a “refresh”) of each list RL, EL will be described layer in detail.

The configuration of the memory system 10 shown in FIG. 2 is merely an example. Therefore, it is a matter of course that the configuration of the memory system 10 is not limited to it.

[1-3. Physical Block]

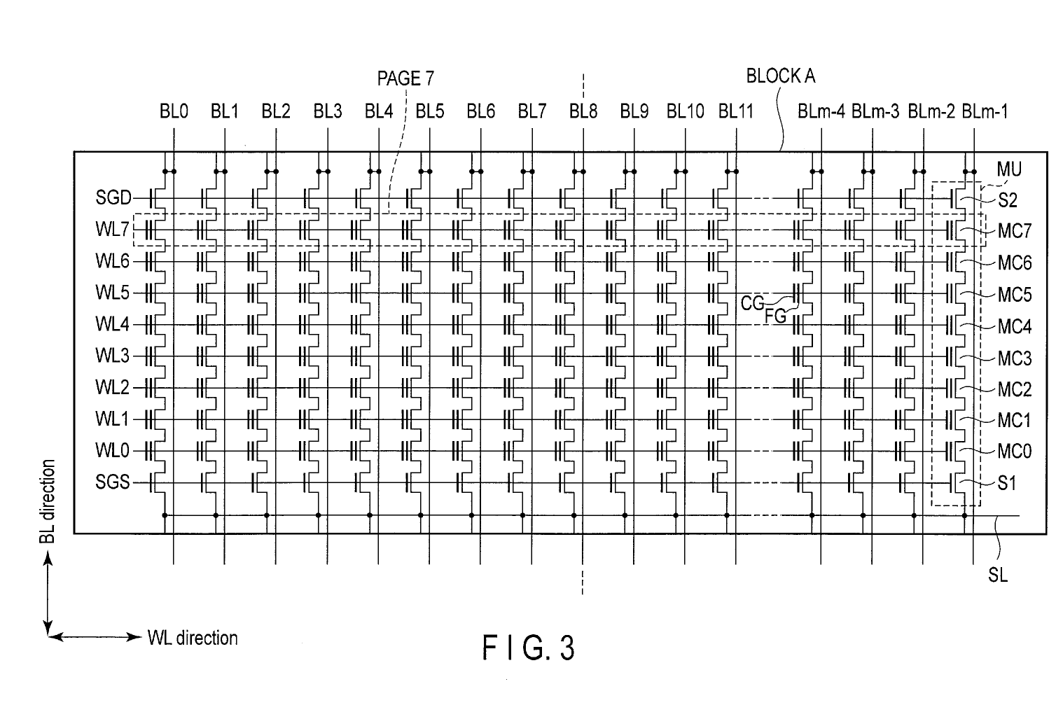

Referring to FIG. 3, a description will be given of the circuit structure of a physical block of the NAND memory 11 shown in FIG. 2. Specifically, a physical block A will be described as an example.

The physical block A comprises a plurality of memory cell units MU arranged in a word-line (WL) direction. The memory cell units MU each comprise a NAND string (memory cell string) extending in a bit-line (BL) direction intersecting the WL direction and including eight memory cells MC0 to MC7, source-side select transistor S1 connected to an end of the current path of the NAND string, and drain-side select transistor S2 connected to the other end of the current path of the NAND string. Memory cells MC0 to MC7 each comprise a control gate CG and a floating gate FG. Although each memory cell unit MU comprises eight memory cells MC0 to MC7, it is not limited to this. Each memory cell unit MU may comprise two or more memory cells, such as 56 or 32 memory cells.

The other ends of the current paths of source-side select transistors S1 of all NAND strings are connected in common to a source line SL. The other ends of the current paths of drain-side select transistors S2 of all NAND strings are connected to respective bit lines BL0 to BLm−1.

Word lines WL0 to WL7 are connected in common to the control gates CG of word-line directional memory cells MC0 to MC7. A select gate line SGS is connected in common to the gate electrodes of word-line directional select transistors S1. Similarly, a select gate line SGD is connected in common to the gate electrodes of word-line directional select transistors S2.

As shown in FIG. 3, respective pages are provided for word lines WL0 to WL7. For instance, a page 7 is provided for word line WL7 as indicated by a broken line. Read and write operations are executed page-by-page. Thus, a page is a unit of reading and a unit of writing. Further, data erasure is executed at a time in the physical block A. Thus, a physical block is a unit of erasure.

[1-4. Structures of Lists RL and EL]

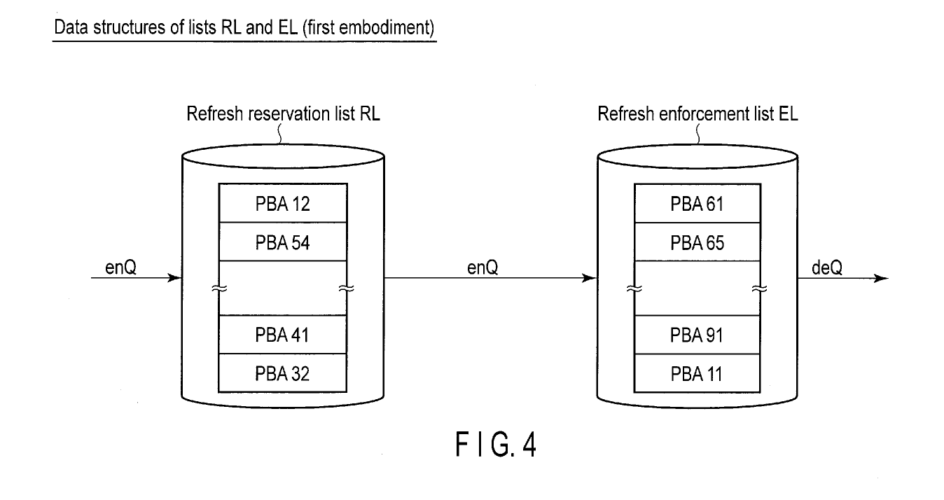

Referring then to FIG. 4, a described will be given of the data structures of the refresh reservation list RL and the refresh enforcement list EL. Each list RL or EL is used, developed on a predetermined RAM, such as a DRAM, in the SSD controller 12.

The refresh reservation list (first list) RL has a queue structure, and sequentially registers physical block addresses PBA of the NAND memory 11 (PBA12, PBA54, . . . , PBA41, PBA32 in the embodiment). It is sufficient if the queue structure is a data structure in which at least data input firstly is output firstly (first-in first-out structure).

The refresh enforcement list (second list) EL also has a queue structure, and sequentially registers physical block addresses PBA of the NAND memory 11 (PBA61, PBA65, . . . , PBA91, PBA11 in the embodiment).

The refresh reservation list RL and the refresh enforcement list EL are connected in series. It is sufficient if, in being connected in “series”, at least an address PBA registered in the refresh reservation list RL is sequentially registered in the refresh enforcement list EL. Therefore, when a new refresh registration is made in the refresh reservation list RL, a physical block address to be registered is enqueued (enQ). At this time, a physical block address registered earliest is deleted from the refresh reservation list RL, i.e., dequeued (deQ) therefrom.

At the same time, the physical block address deleted from the refresh reservation list RL is registered in the refresh enforcement list EL, i.e., enqueued (enQ) in the refresh enforcement list EL. Further, at this time, a physical block address registered earliest is deleted from the refresh enforcement list EL, i.e., dequeued (deQ) therefrom. Thus, a refresh operation is sequentially executed, beginning with the physical address deleted from the refresh enforcement list EL.

There is no limitation on the data size of each list RL or EL. Therefore, all physical block addresses of the NAND memory 11 can be registered simultaneously in each list RL or EL. Further, although in the embodiment, each of the reservation and enforcement lists RL and EL has a queue structure, their data structures are not limited to this. It is a matter of course that the structures can be modified as the occasion demands. Further, the lists RL and EL may have a form of a table, instead of the list form, or may be expressed by numerical expressions.

### 2. Operations

A description will now be given of operations performed by the memory system 10 of the first embodiment constructed as the above.

[2-1. Refresh Operation]

Firstly, a refresh operation will be described briefly.

The refresh operation (refresh) is an operation whereby, in order to prevent errors due to data retention (DR), read disturb (RD), etc., data stored in the NAND memory 11 is returned to a state assumed immediately after the data was written, using the method 1 or 2, below. However, the state to be assumed by the refresh operation is not limited to the state assumed immediately after the data was written. The “refresh” is sufficient if the data is restored to a state in which it is free from a read error.

Method 1: The data of a physical block as a refresh target is copied (written) to another physical block in the NAND memory 11.

Method 2: The data of a physical block as a refresh target is temporarily copied for saving to another physical block in the NAND memory 11, and the data of the physical block as the refresh target is erased. After that, the temporarily copied data is returned to the physical block.

By the above method 1 or 2, the refreshed NAND memory 11 is returned to a state in which correct data immediately after it was written is stored. As a result, occurrence of a read error in the NAND memory 11 can be prevented in advance.

Method 1 or 2 is executed on the NAND memory 11 by the NANDC 130 under control of CPU 123B. Further, as write data to be copied or returned (written back) to a block, write data stored in a cache included in the NAND memory 11 can be used, for example.

Further, factors that require the above refresh include, for example, fatigue of the memory cell MC. More specifically, the factors include the following:

Factor 1: A predetermined period has elapsed from writing (countermeasures against DR).

Factor 2: The number of data reads is not less than a predetermined number (countermeasures against RD).

Factor 3: Error bits not less than a predetermined threshold have occurred during reading.

Further, errors due to data retention (DR) are considered to occur for the following factor: Namely, electrons accumulated in the floating electrode FG of a memory cell MC in the NAND memory 11 move into the semiconductor substrate with time. If this is not stopped, the logical value in the floating electrode FG varies, which makes it impossible to execute correct data reading (occurrence of a read error).

An error due to read disturb (RD) will be caused by the following factor: Namely, when data is read from the NAND memory 11, a predetermined read voltage, for example, is applied not only to a selected memory cell MC, but also to non-selected memory cells MC around the selected memory cell. By this voltage application, a small number of electrons are also injected into the floating gates FG of the non-selected memory cells MC. If this phenomenon is repeated, the logical values of the non-selected memory cells MC will vary, which makes it impossible to correctly read data (occurrence of a read error).

[2-2. Refresh Execution Determination Processing]

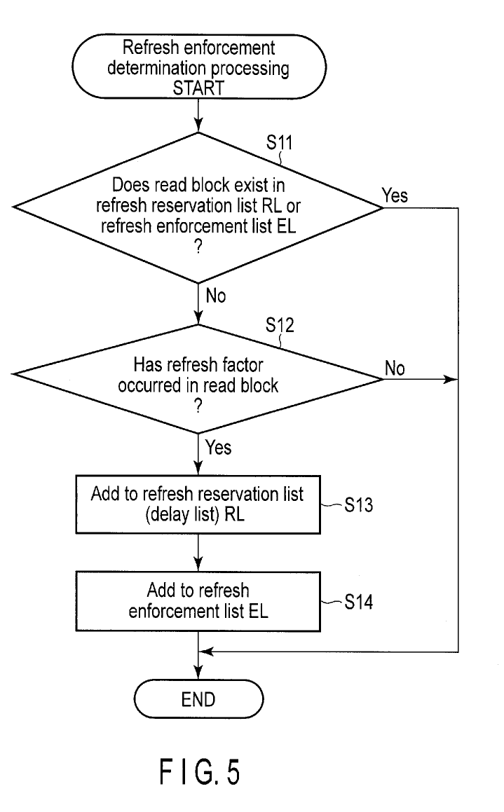

Referring then to FIG. 5, a description will be given of refresh execution determination processing.

Firstly, in step S11 of FIG. 5, CPU 123B determines whether a block, from which data is read, already exists in the refresh reservation list RL or the refresh enforcement list EL. More specifically, CPU 123B refers to the lists RL and EL, thereby determining whether the physical block address PBA of a data-read block is identical to one of the physical block addresses registered in the lists RL and EL. If the physical address exists in the list RL or EL (Yes in step S11), this operation is finished.

If the physical address does not exist in the list RL or EL (No in step S11), in step S12, CPU 123B determines whether a refresh factor has occurred in the data-read physical block. More specifically, CPU 123B determines whether refresh is necessary, based on the above-mentioned refresh factors 1) to 3). If determining that no refresh is necessary (No in step S12), CPU 123B finishes the operation.

If determining that refresh is necessary (Yes in step S12), in step S13, CPU 123B registers the physical block address of the block into the refresh reservation list RL.

In step S14, CPU 123B registers the physical block address deleted from the refresh reservation list RL into the refresh enforcement list EL.

[2-3. Delayed Refresh Processing]

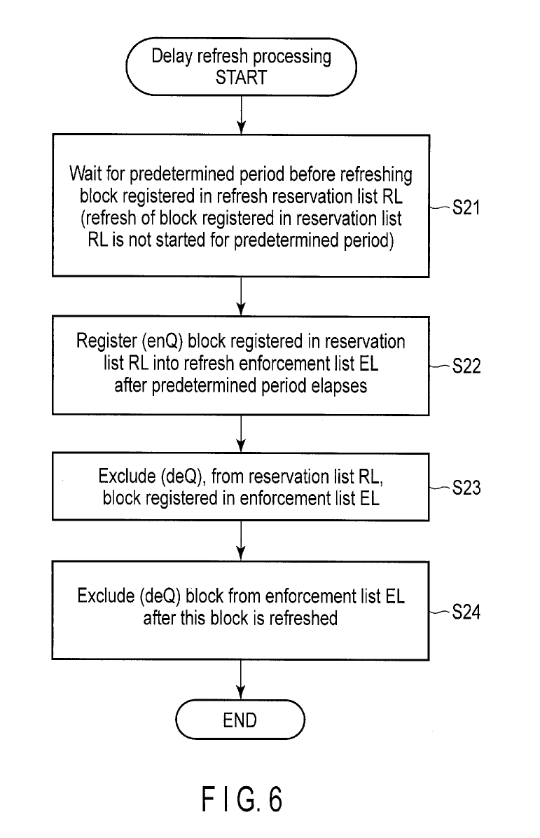

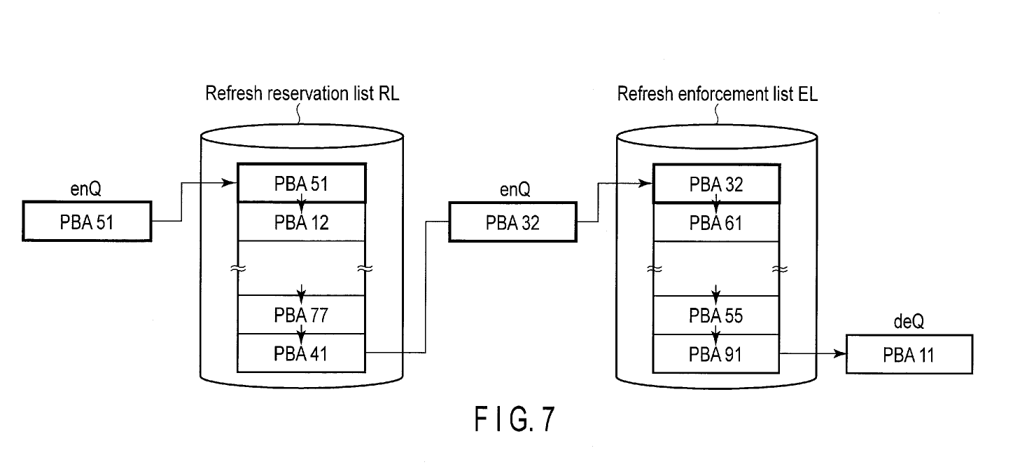

Referring then to FIGS. 6 and 7, a description will be given of delayed refresh processing. The delayed refresh processing means processing corresponding to processing of steps S13 and S14 included in the refresh execution determination processing shown in FIG. 5.

In step S21 of FIG. 6, CPU 123B stands by (waits, or stops) for a predetermined period (for example, about 10 seconds) before execution of refresh of the physical block address registered in the refresh reservation list RL in step S13 of FIG. 5. In other words, CPU 123B does not start refresh of the physical block address, registered in the refresh reservation list RL, for a predetermined period.

“The time of registration” is sufficient if the refresh of the physical block address is started at least when the physical address block PBA registered in the refresh reservation list RL is registered into the refresh enforcement list EL. The time of registration is not limited to a time immediately after the elapse of the predetermined period. For instance, the registration may be performed when a physical block address registered in the refresh reservation list RL coincides with a physical block address used for a patrol read. The patrol read means periodical reading of data from the NAND memory 11 executed to detect accumulated errors due to data retention before correction of the errors becomes impossible. If a physical block address registered in the refresh reservation list RL is a target of patrol reading, the degree of fatigue of a corresponding memory cell MC may have progressed. In other words, the “fatigue” may include degradation, reduction memory capacity of the memory cell MC and reduction function of the memory cell MC.

In step S22, CPU 123B registers (enQ) a block address into the refresh enforcement list EL after a predetermined period elapses from the registration of the block address in the refresh reservation list RL. For instance, as shown in FIG. 7, CPU 123B registers (enQ) physical block address PBA32 that was registered earliest in the refresh reservation list RL into the refresh enforcement list EL after a predetermined period elapses. At this time, CPU 123B registers (enQ) subsequent physical block address PBA51 in the refresh reservation list RL.

In step S23, CPU 123B excludes (deQ) the block address registered in the refresh enforcement list EL from the refresh reservation list RL. For instance, as shown in FIG. 7, CPU 123B deletes (deQ) physical block address PBA32 registered in the refresh enforcement list EL from the refresh reservation list RL.

In step S24, CPU 123B deletes (deQ) a physical block address after this address is refreshed from the refresh enforcement list EL. For instance, as shown in FIG. 7, CPU 123B executes a refresh operation on physical block address PBA11 that was registered earliest in the refresh enforcement list EL. After completion of the refresh, CPU 123B deletes (deQ), from the refresh enforcement list EL, physical block address PBA11 having been refreshed. Delayed refresh operation is repeated in the same way as the above.

### 3. Advantageous Effect

The memory system 10 of the first embodiment, which is constructed and operates as described above, will provide at least advantageous effects 1 and 2, below.

(1) The latency of the memory system 10 due to refresh can be shortened.

In other words, exposure of performance reduction of the memory system 10 due to refresh can be avoided. This advantage is conspicuous in, for example, a state in which refresh factors sequentially occur.

This advantage will further be described by comparing the first embodiment with a comparative example.

### A) Comparative Example

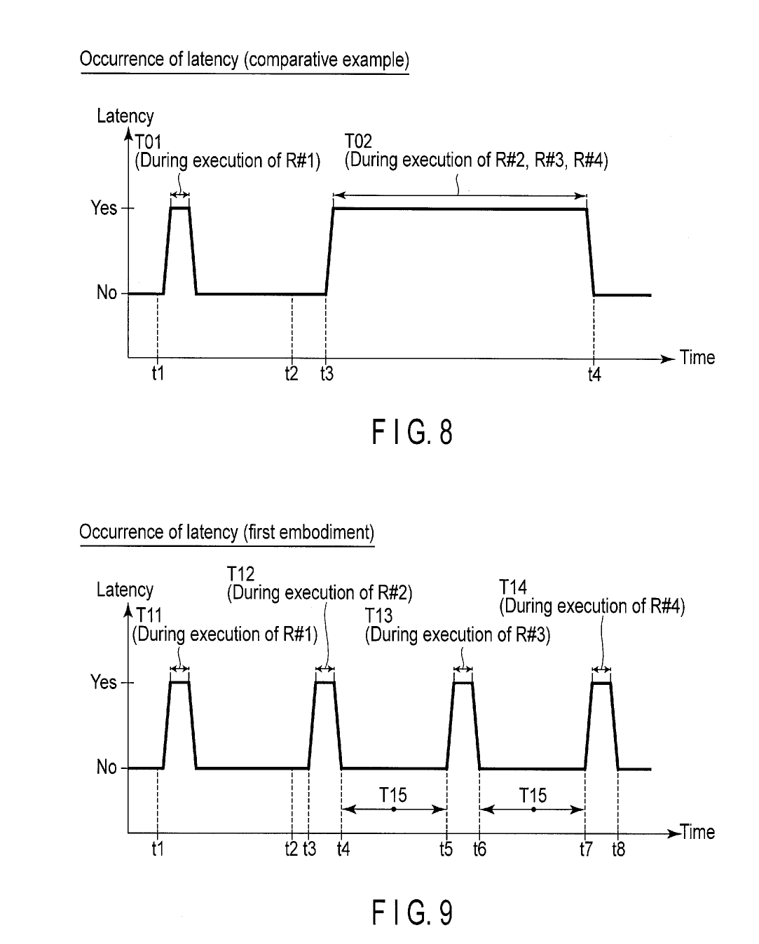

A comparative example does not comprise the configuration of the memory system 10 of the first embodiment, and does not operate like the memory system 10. Accordingly, when refresh factors have occurred sequentially, the period of latency of the comparative memory system is increased, as is shown in FIG. 8.

More specifically, assuming that a first refresh factor has occurred at time point t1 in FIG. 8, the memory system executes refresh R#1 corresponding to the first refresh factor. In period T01 in which refresh R#1 is executed, a request from a host cannot be executed. Thus, in period T01, the memory system exhibits a latency state.

Further, assuming that second to fourth refresh factors have sequentially occurred at time point t2, the memory system executes, at time point t3, refreshes R#2 to R#4 corresponding to the second to fourth refresh factors. In period T02 in which refreshes R#2 to R#4 are executed, when a command from the host is executed, it is intermittently interrupted by the execution of refreshes R#2 to R#4. As a result, performance reduction of the memory system will be exposed.

Thus, in period T02, the memory system exhibits a much longer latency state. In other words, in this comparative example, in period T02, performance reduction of the memory system will be quite apparent to the host side.

### B) First Embodiment

The memory system 10 of the first embodiment comprises the refresh reservation list RL and the refresh enforcement list EL at least, compared to the comparative example.

According to the configuration and operation of the memory system 10 of the first embodiment, even when refresh factors have sequentially occurred, the latency of the memory system 10 can be prevented from increasing, as is shown in FIG. 9.

More specifically, if CPU 123B determines at time t1 in FIG. 9 that a first refresh factor has occurred in a physical block from which data is read (Yes in step S12 of FIG. 5), it registers the address of the physical block into the refresh reservation list RL (S13). Subsequently, CPU 123B of the memory system 10 registers the physical block address into the refresh enforcement list EL a predetermined period after, thereby executing refresh R#1 of the physical block address corresponding to the first refresh (S14).

If at time t2, CPU 123B determines that second to fourth refresh factors have sequentially occurred in physical blocks from which data is read (Yes in S12), it registers physical block addresses corresponding to the second to fourth refresh factors into the refresh reservation list RL (S13).

At time t3, after a predetermined period elapses, CPU 123B registers the physical block address corresponding to the second refresh factor into the refresh enforcement list EL, thereby executing refresh R#2 of the physical block address due to the second refresh factor (S14).

At time t4 at which refresh R#2 has completed, CPU 123B deletes the physical block address corresponding to refresh R#2 from the refresh enforcement list EL.

At time t5 (i.e., a time predetermined period T15 after time t4), CPU 123B registers the physical block address corresponding to the third refresh factor into the refresh enforcement list EL, thereby executing refresh R#3 of the physical block address due to the third refresh factor (S14).

At time t6 at which refresh R#3 has completed, CPU 123B deletes the physical block address corresponding to refresh R#3 from the refresh enforcement list EL.

At time t7 (i.e., a time predetermined period T15 after time t6), CPU 123B registers the physical block address corresponding to the fourth refresh factor into the refresh enforcement list EL, thereby executing refresh R#4 of the physical block address due to the fourth refresh factor (S14).

At time t8 at which refresh R#4 has completed, CPU 123B deletes the physical block address corresponding to refresh R#4 from the refresh enforcement list EL.

As described above, the memory system 10 of the first embodiment does not sequentially execute refresh even if refresh factors have sequentially occurred. Instead, the memory system 10 firstly registers a physical block address corresponding to each refresh factor into the refresh reservation list RL, and registers the physical block address into the refresh enforcement list EL predetermined period T15 after. Thus, by imparting delay period T15 to each of the cases where refresh factors have sequentially occurred, refresh operations are executed individually. In other words, “predetermined period (delay period) T15” is a period ranging from the time when a physical block address PBA is registered into the refresh reservation list RL, to the time when the physical block address PBA is registered into the refresh enforcement list EL.

Further, respective periods T12 to T14 are in which respective refresh operations R#2 to R#4 are executed.

Accordingly, latency periods T12 to T14 in the first embodiment can be set much shorter than latency period T02 in the comparative example. In other words, in the memory system 10 of the first embodiment, reduction in the performance of the memory system 10 in each period T12 to T4 can be prevented from being apparent to the host 20 side.

(2) Refresh can be executed when necessary.

Delay period T15, after which each of refresh operations R#2 to R#4 is executed, is not limited to a certain period, but may be arbitrarily set. More specifically, in step S22, CPU 123B can set delay period T15 by selecting a delay time, after which a physical block address as a refresh target is supplied from the refresh reservation list RL to the refresh enforcement list EL.

For instance, if CPU 123B determines that the degree of fatigue of the memory cell MC is high, it can set delay period T15 shorter. In this case, refresh operations are executed relatively frequently. Therefore, in this case, risk of data damage can be further reduced.

In contrast, if CPU 123B determines that the degree of fatigue of the memory cell MC is low, it can set delay period T15 longer. In this case, the frequency of refresh operations is reduced. Therefore, in this case, the overall latency of the memory system 10 can be further reduced.

As described above, by selectively setting delay period T15 in consideration of the above-mentioned merits, refresh can be executed with good timing.

### Second Embodiment

### Directed to Selective Use of the Lists RL and EL

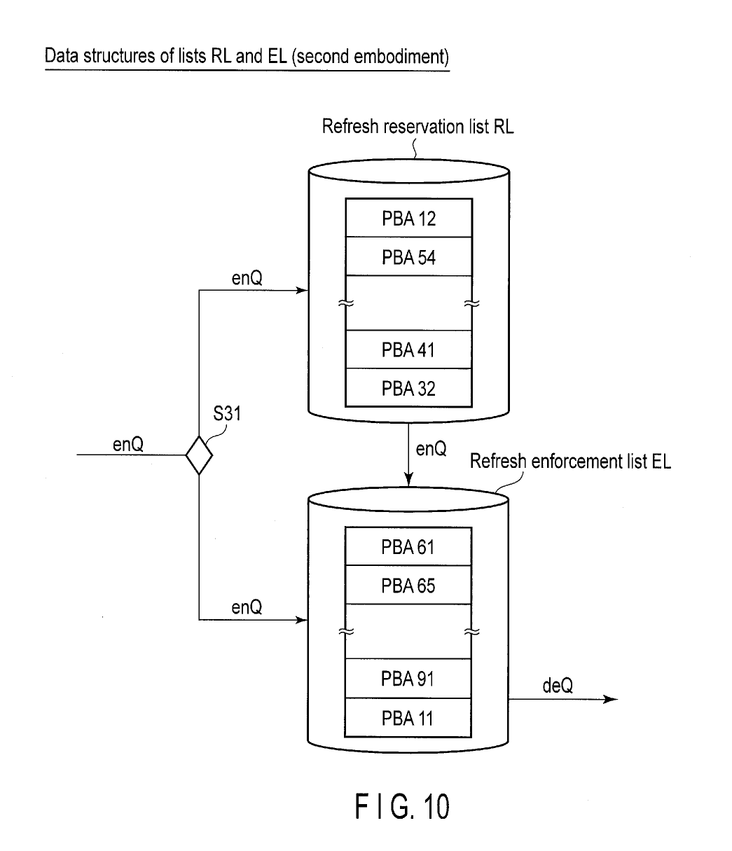

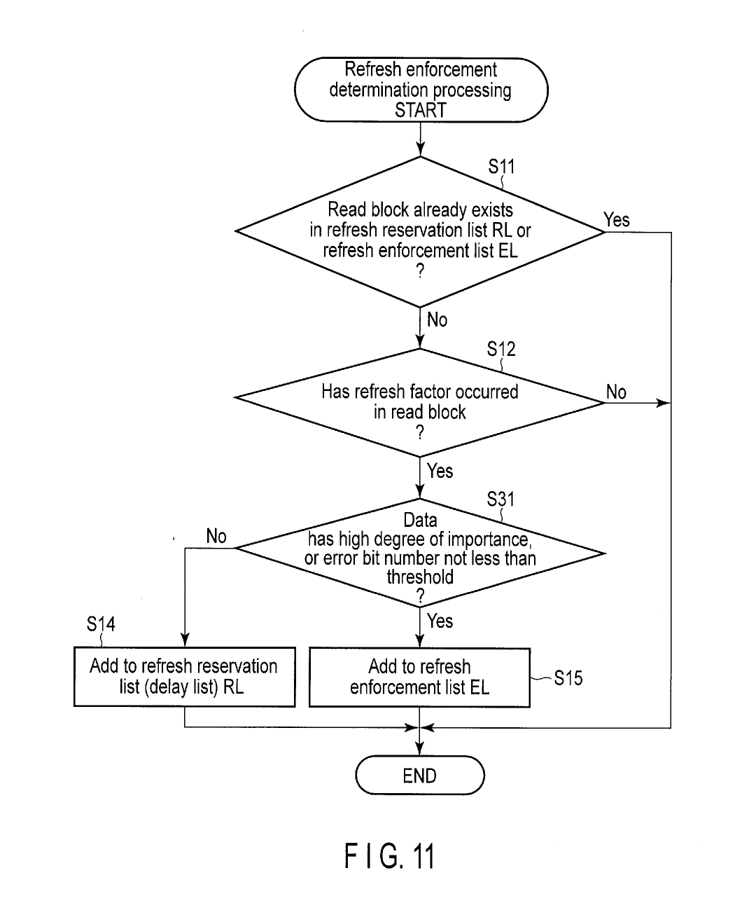

Referring then to FIGS. 10 and 11, a memory system 10 according to a second embodiment will be described. The second embodiment is directed to selective use of the lists RL and EL. In the second embodiment, elements similar to those of the first embodiment are not described in detail.

[Data Structures of the Lists RL and EL]

Referring to FIG. 10, the data structures of the refresh reservation list RL and the refresh enforcement list EL according to the second embodiment will be described.

As shown in FIG. 10, the second embodiment differs from the first embodiment in that in the former, the refresh reservation list RL and the refresh enforcement list EL are connected in parallel via determination step S31, described later. In being connected in “parallel”, an address PBA is registered at least into either the refresh reservation list RL or the refresh enforcement list EL.

By virtue of the above structure, a physical block address needed to be refreshed is subjected either to registration into the refresh reservation list RL (hereinafter, this may be referred to as “a delay refresh”) or to registration into the refresh enforcement list EL (hereinafter, this may be referred to as “a real-time refresh”).

If registration into the refresh reservation list RL is selected, the physical block address is registered (enQ) into the refresh reservation list RL.

Subsequently, the physical block address in the refresh reservation list RL is registered (enQ) into the refresh enforcement list EL., thereby executing refresh.

In contrast, if registration into the refresh enforcement list EL is selected, the physical block address is registered (enQ) into the refresh enforcement list EL. In this case, the registered physical block address is preferentially refreshed, compared to a physical block address registered in the refresh reservation list RL. These types of processing will be described later.

The other structures are substantially the same as those of the first embodiment, and are therefore not described in detail.

[Refresh Enforcement Determination Processing]

Referring now to FIG. 11, a description will be given of refresh enforcement determination processing of the memory system 10 executed in the above-described structure.

As shown in FIG. 11, refresh enforcement determination processing according to the second embodiment further comprises determination step S31, in addition to the steps of the first embodiment.

Namely, in step S31, CPU 123B determines whether a physical block address, at which a refresh factor has occurred, should be registered into the refresh reservation list RL or the refresh enforcement list EL. More specifically, CPU 123B determines the same, based on whether read data of the physical block address is data with a high degree of importance, or on whether the number of error bits is not less than a predetermined threshold during reading.

If the read data of the physical block address is data with a low degree of importance, or if the number of error bits is less than the predetermined threshold during reading, CPU 123B performs control to execute the above-described step S14.

In contrast, if the read data of the physical block address is data with a high degree importance, or if the number of error bits is not less than the predetermined threshold during reading, CPU 123B performs control to execute the above-described step S15.

The other operations are substantially the same as those of the first embodiment, and hence will not be described in detail.

### Advantageous Effect

As described above, the configuration and operation of the memory system 10 of the second embodiment can provide at least advantageous effect similar to those described in the above items (1) and (2). The memory system 10 of the second embodiment can further provide the following advantageous effect (3) at least.

(3) By selectively executing the delay refresh and the real-time refresh, increase in the latency due to the delay refresh can be prevented, and at the same time, enhancement of reliability due to real-time refresh can be realized.

In the memory system 10 of the second embodiment, the refresh reservation list RL and the refresh enforcement list EL are connected in parallel via determination step S31 (FIG. 10).

Accordingly, CPU 123B selectively determines whether a physical block address corresponding to read data should be registered into the refresh reservation list RL or the refresh enforcement list EL, based on whether the read data is, for example, data with a high degree of importance (steps S31, S14 and S15 in FIG. 11).

As described above, the memory system 10 of the second embodiment can provide both the advantage of preventing latency by the delay refresh, and the advantage of enhancing reliability by the real-time refresh.

The criterion of the determination in step S31 is not limited to the degree of, for example, importance of data. For instance, other criteria, such as a shift direction during a shift read, a shift amount (the degree of seriousness of an error), and the type of refresh target data, can be used. The shift read will be described later in detail

### Modification 1

### An Example of Use of Shift Read

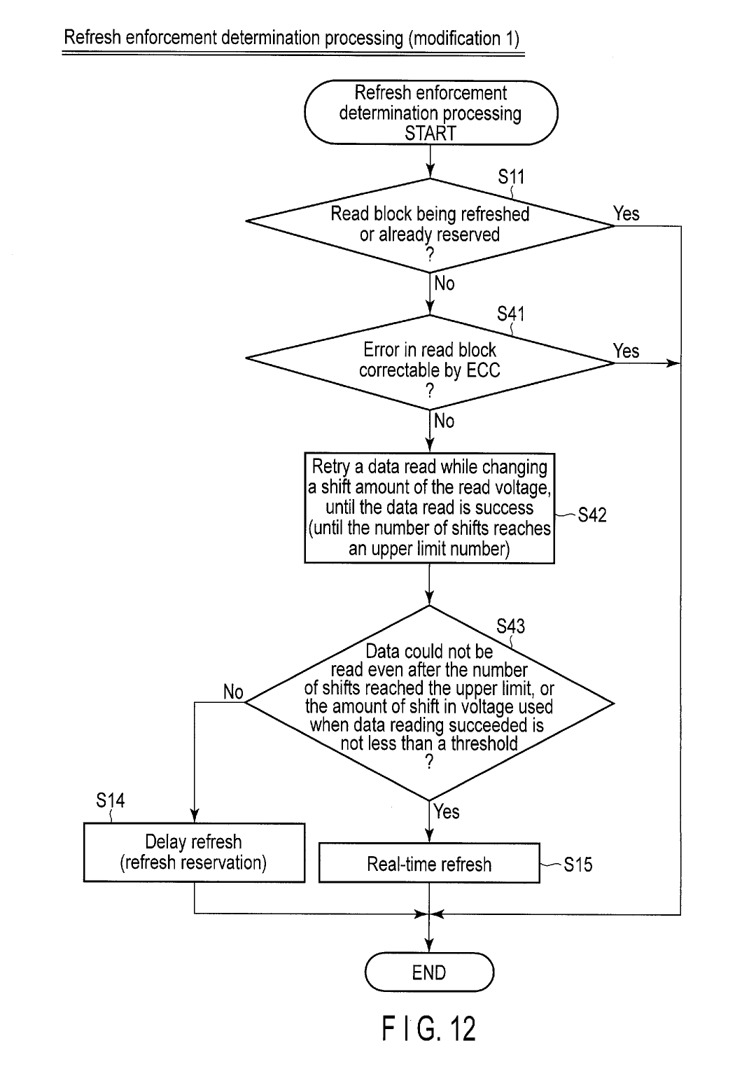

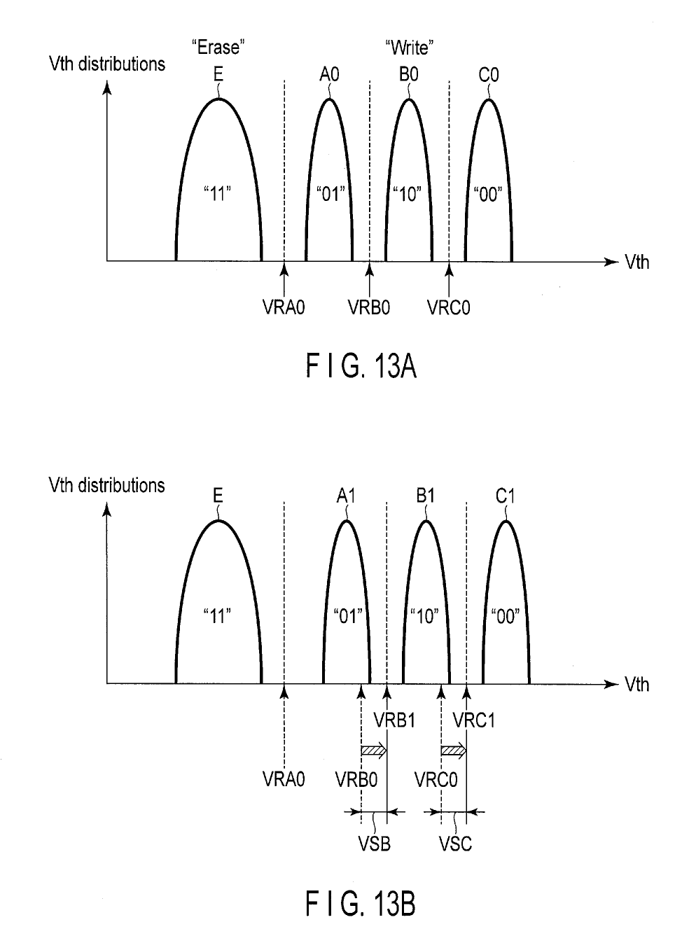

Referring to FIGS. 12, 13A and 13B, a memory system 10 according to modification 1 will be described. Modification 1 is directed to a case where the degree of seriousness (a shift amount during shift read) of an error is used as a criterion for the determination of step S31. In the modification, elements similar to those of the first and second embodiments will not be described in detail.

[Refresh Enforcement Determination Processing]

Referring to FIG. 12, refresh enforcement determination processing performed in the memory system 10 of modification 1 will be described.

As shown in FIG. 12, refresh enforcement determination processing according to modification 1 further comprises steps S41, S42 and S43 in addition to the steps of the second embodiment.

In step S41, CPU 123B determines whether data read from the NAND memory 11 can be error-corrected by the ECC 129. If the data can be error-corrected (Yes in S41), CPU 123B finishes the processing.

If the data cannot be error-corrected (No in S41), CPU 123B executes, in step S42, data reading while changing the shift amount of a read voltage VR (hereinafter, this will be referred to as a “shift read”). CPU 123B executes data reading while changing the shift amount of the read voltage VR, until data reading succeeds (until the number of shifts reaches an upper limit number).

[Regarding Shift Read]

Referring to FIGS. 13A and 13B, the shift read operation in step S42 will be described in more detail. FIG. 13A shows threshold voltages in an initial state (immediately after data writing). FIG. 13B shows threshold voltages during a shift read (when the threshold voltage shifts from a value assumed in the initial state). These figures show threshold distribution examples of a multi-level cell (MLC). The MLC indicates a memory cell MC capable of storing multi-bit data.

As shown in FIG. 13A, if two bits are held in one memory cell MC by more finely controlling the amount of electrons injected into a floating gate during wring in the MLC, four threshold distributions E, A0, B0 and C0 are formed. In this case, the MLC is a four-level memory cell. One MLC is not limited to four levels. If, for example, one memory cell holds three bits, eight threshold distributions can be formed in a similar manner. Bit numbers ‘11’, ‘01’, ‘10’ and ‘00’ are assigned to four distributions (Vth distributions) E, A0, B0 and C0 of a four-level memory cell shown, respectively, in the increasing order of threshold voltage.

The threshold distribution shown in FIG. 13A is assumed to be an initial-state distribution (immediately after data writing). Accordingly, there is little shift in four threshold distributions E, A0, B0 and C0 from those exhibiting when the data writing is executed. As a result, read voltages VRA0, VRB0 and VRC0 in the initial state correspond to the voltages near the central portions between four threshold distributions E, A0, B0 and C0.

In contrast, threshold distributions A1, B1 and C1 during a shift read are shifted such that the threshold voltage Vth is increased by predetermined shift amounts VSB and VSC, as is shown in FIG. 13B. Factors causing the shift amounts may include, for example, the above-mentioned factor 1) (i.e., a predetermined period has elapsed), factor 2) (the number of data reads exceeds a predetermined number), and variations in characteristics among memory cells MC due to manufacturing processes.

In step S42, CPU 123B can read data even from the NAND memory 11 having threshold voltages varied, by executing a shift read. More specifically, CPU 123B controls the NANDC 130 to increase the necessary read voltage levels (VRB0=>VRB1, VRC0=>VRC1), thereby reading data, based on the threshold distributions A1, B1 and C1, as is shown in FIG. 13B.

As described above, a “shift read” is a data read using a read voltage (of, for example, VRB1, VRC1, etc.) at least other than such read voltages as VRA0 VRB0 and VRC0. Note that, the “shift read” may vary at least the read voltage (for example, VRB0, VRC0) in reading operation.

Returning to FIG. 12, CPU 123B determines in step S43 whether data could not be read even after the number of shifts reached the upper limit, or whether the amount of shift in the read voltage used when data reading succeeded is not less than a threshold.

More specifically, CPU 123B determines whether the difference (shift amount) VSB, VSC between read voltage level VRB1, VRC1 at which a data read has succeeded and read voltage level VRB0, VRC0 in an initial (default) state exceed respective predetermined thresholds. This is because it can be expected such that the greater the difference (shift amount) VSB or VSC, the greater the degree of fatigue of the memory cell MC, and hence the degree of seriousness of an error in the cell MC. Accordingly, CPU 123B can determine that the degree of seriousness of the error is high, if the difference VSB or VSC exceeds the predetermined threshold.

Similarly, if data could not be read even after the number of shifts reached the upper limit, CPU 123B determines in step S43 that the degree of seriousness of an error is high. This is because in this case, it is apparent that the degree of seriousness of an error is high.

If CPU 123B determines in step S14 that the degree of seriousness of an error is low (No in S43), it registers the physical block address into the refresh reservation list RL, thereby executing a delay refresh.

In contrast, if CPU 123B determines in step S15 that the degree of seriousness of an error is high (Yes in S43), it registers the physical block address into the refresh enforcement list EL, thereby executing a real-time refresh.

Although the determination in step S43 is based on the shift amount VSB or VSC, the embodiments are not limited to this. For instance, the determination may be executed in step S43 based on a shift direction (in which the voltage level is increased or reduced) during a read shift.

Further, although a 4-level MLC is used as an example of a memory cell MC for shift reading, the embodiments are not limited to this. For instance, an 8-level or 16-level MLC may be employed. A shift read can be executed even on a single level cell (SLC) that can store one-bit data.

In addition, if there is no latency in the memory system 10, CPU 123B can collectively execute a refresh in accordance with an instruction from the host 20.

The other structures and operations are substantially the same as those of the first and second embodiments, and are therefore not described in detail.

### Advantageous Effect

As described above, the configuration and operation of the memory system 10 of modification 1 can provide advantageous effects similar to at least those described in the above items (1) to (3).

The memory system 10 of modification 1 can use the degree of seriousness of an error (i.e., a shift amount during a shift read) as a criterion for the determination of step S31. Thus, modification 1 can be modified as circumstances demand.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a nonvolatile memory;
a controller configured to control the nonvolatile memory; and
a first list and a second list that register address information in the nonvolatile memory,
wherein the controller is configured to
read first data from the nonvolatile memory;
determine whether refresh operation is executed based on the first data read out from the nonvolatile memory;
register address information of the first data into the first list, when refresh operation is determined to be executed;
register the address information registered in the first list into the second list; and
execute refresh operation based on the address information registered in the second list.

2. The memory system of claim 1, wherein the controller stands by for a period until the address information registered in the first list is registered into the second list.

3. The memory system of claim 2, wherein
the nonvolatile memory comprises at least one memory cell; and
the controller sets the period shorter when a degree of fatigue of the at least one memory cell is determined to be high, and sets the period longer when the degree of fatigue of the at least one memory cell is determined to be low.

4. The memory system of claim 1, wherein the first and second lists have queue structures and are used in a series.

5. The memory system of claim 1, wherein the controller controls a time when the address information registered in the first list is registered into the second list, based on a degree of fatigue of the nonvolatile memory.

6. The memory system of claim 1, wherein the controller registers the address information of the first data into one of the first and second lists, when the refresh operation is executed.

7. The memory system of claim 6, wherein the first and second lists have queue structures and are used in a parallel.

8. The memory system of claim 6, wherein the controller selects one of the first and second lists, based on whether the first data is importance data, or whether number of error bits is not less than a threshold.

9. The memory system of claim 6, wherein the controller determines whether error correction can be executed on the first data.

10. The memory system of claim 9, wherein the controller executes shift read operation on the nonvolatile memory when error correction cannot be executed on the first data.

11. The memory system of claim 10, wherein the nonvolatile memory is a NAND flash memory comprising a plurality of memory cells.

12. The memory system of claim 10, wherein when executing the shift read operation, the controller executes data reading, with a shift amount varied, until the data reading succeeds, or executes data reading, with the shift amount varied, until number of data reads reaches an upper limit.

13. The memory system of claim 12, wherein the controller selects one of the first and second lists, based on the shift amount or the shift direction.
